(19) United States
(12) Patent Application Publication
(10) Pub. No.: US 2007/0236929 A1
(43) Pub. Date: Oct. 11, 2007

(54) Backlight module having reflection layer and liquid crystal display using same

(75) Inventors: Wei-Hao Hung, Miao-Li (TW); Chien-Chung Fang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/784,845

(22) Filed: Apr. 9, 2007

(30) Foreign Application Priority Data
Apr. 7, 2006 (TW) 95112475

(51) Int. Cl. F21V 9/08; F21V 7/00

(52) U.S. Cl. 362/231; 362/247

(57) ABSTRACT

An exemplary backlight module (2) includes a light source (21) having at least two light emitting diodes (211), and a reflection layer (218). Each light emitting diode includes a top surface (214), a side surface (215) adjacent to the top surface. Each of the light emitting diodes configured to emit different colored light respectively. The reflection layer is formed on the top surface of the light emitting diode.

### FIELD OF THE INVENTION

The present invention relates to backlight modules and liquid crystal displays, and more particularly to a backlight module of a liquid crystal display configured to provide a reflection layer for improving color mixing of various light emitting diodes thereat.

### GENERAL BACKGROUND

A typical liquid crystal display (LCD) generally includes a liquid crystal panel and a backlight module. The backlight module generally includes a reflection sheet, a light source, a diffuser, and a brightness enhancement film. The light source of the backlight module can be one or more cold cathode fluorescent lamps, or one or more light emitting diodes (LEDs). A backlight module using LEDs as a light source can include three different types of LEDs, which emit red, green, and blue light beams respectively. After mixing of the color light beams emitted by the red, green, and blue LEDs, a planar white light source can be provided by the backlight module. The planar white light source illuminates the liquid crystal panel.

Referring to FIG. 5, this is a schematic, exploded, isometric view of a conventional backlight module 1. The backlight module 1 includes a reflection sheet 14, a plurality of light sources 11, a diffuser 12, and a brightness enhancement film 13. The light sources 11 are formed on the reflection sheet 14. Each light source 11 includes a red LED 111, a green LED 112, and a blue LED 113. The diffuser 12 is formed on the light sources 11 opposite to the reflection sheet 14. The brightness enhancement film 13 is formed on the diffuser 12.

Some of the light beams emitted by the red, green, and blue LEDs 111, 112, 113 are mixed and enter the diffuser 12 directly. Other of the light beams are mixed and reflected by the reflection sheet 14, and then mixed again before entering the diffuser 12. Then all the light beams are mixed and scattered by the diffuser 12 to form substantially white light, which then enters the brightness enhancement film 13.

Referring to FIG. 6, this is an enlarged side view of part of the backlight module 1. Each of the red, green, and blue LEDs 111, 112, 113 has a similar structure. Taking the red LED 111 as an example, the red LED 111 includes a top surface 114 and at least two side surfaces 115. The top surface 114 is adjacent and substantially perpendicular to the side surfaces 115. The light beams can emit from both the top and side surfaces 114, 115. A light path from the top surface 114 to the diffuser 12 is shorter than that from the side surface 115 to the diffuser 12. That is, the light beams of the same color transmitting along different light paths will mix unevenly with other light beams of other colors. Therefore, a color shift is liable to occur within the planar white light source. This in turn impairs the display quality of the liquid crystal display using the backlight module 1.

Accordingly, what is needed is a backlight module of a liquid crystal display configured to overcome the above-described problems.

### SUMMARY

An exemplary backlight module includes a light source having at least two light emitting diodes, and a reflection layer. Each light emitting diode includes a top surface, a side surface adjacent to the top surface. Each of the light emitting diodes configured to emit different colored light respectively. The reflection layer is formed on the top surface of the light emitting diode.

A detailed description of embodiments of the present invention is given below with reference to the accompanying drawings.

### BRIEF DESCRIPTION OF THE DRAWINGS

In the drawings, all the views are schematic.

FIG. 1 is an exploded, isometric view of a backlight module in accordance with a first embodiment of the present invention.

FIG. 2 is an enlarged, side plan view of part of the backlight module of FIG. 1.

FIG. 3 is a side plan view of part of a backlight module in accordance with a second embodiment of the present invention.

FIG. 4 is a side plan view of a liquid crystal display in accordance with a third embodiment of the present invention, the liquid crystal display incorporating the backlight module of FIG. 1.

FIG. 5 is an exploded, isometric view of a conventional backlight module.

FIG. 6 is an enlarged, side plan view of part of the backlight module of FIG. 5.

### DETAILED DESCRIPTION OF PREFERRED EMBODIMENTS

Referring to FIG. 1, this is a schematic, exploded, isometric view of a backlight module 2 in accordance with a first embodiment of the present invention. The backlight module 2 includes a plurality of light sources 21, a diffuser 22, a brightness enhancement film 23, and a reflection sheet 24. The light sources 21 are formed on the reflection sheet 24. Each light source 21 includes a red LED 211, a green LED 212, and a blue LED 213. The diffuser 22 is formed on the light source 21 opposite to the reflection sheet 24. The brightness enhancement film 23 is formed on the diffuser 22.

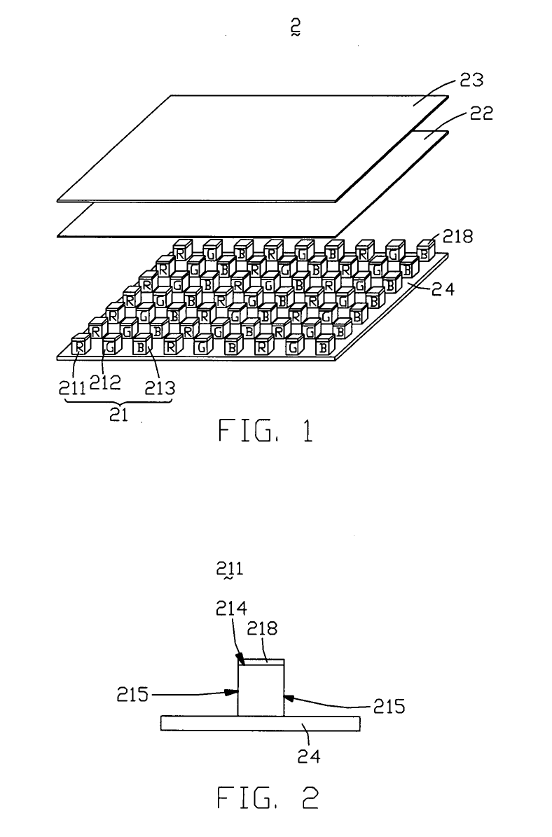

Referring to FIG. 2, this is an enlarged, side plan view of part of the backlight module 2. Each of the red, green, and blue LEDs 211, 212, 213 has a similar structure. Taking the red LED 211 as an example, the red LED 211 includes a top surface 214 and at least two side surfaces 215. The top surface 214 is adjacent and substantially perpendicular to the side surfaces 215. The light beams can emit from both the top and side surfaces 214, 215. A reflection layer 218 is formed on the top surface 214 of the red LED 211. The reflection layer 218 can be formed by coating or adhering a reflective material on the top surface 214. The reflective material can for example be a silver layer.

Some of the light beams emitted by the red, green, and blue LEDs 211, 212, 213 emit from the side surface 215, are mixed and enter the diffuser 22 directly or are mixed and reflected by the reflection sheet 24, and then enter the diffuser 22. Other of the light beams are reflected by the reflection layer 218 on the top surface 214, emit from the side surface 215, are mixed and enter the diffuser 22 directly or are mixed and reflected by the reflection sheet 24, and then enter the diffuser 22. Then all the light beams are mixed and scattered by the diffuser 22 to become substantially white light, which then enters the brightness enhancement film 23.

The light beams can emit out from the red LED 211 through the top and the side surfaces 214, 215. However, the light beams emitted toward the top surface 214 are reflected by the reflection layer 218, and then the reflected light is guided toward and emitted out from the red LED 211 from the side surfaces 215.

All the light are emitted out from the red LED 211 through the side surfaces 215. Therefore, there are as few as only two different light paths for transmitting the light beams to the diffuser 22. Accordingly, a color difference caused by different color mixing between various light paths can be reduced, and the planar light source yielded is more uniformly white.

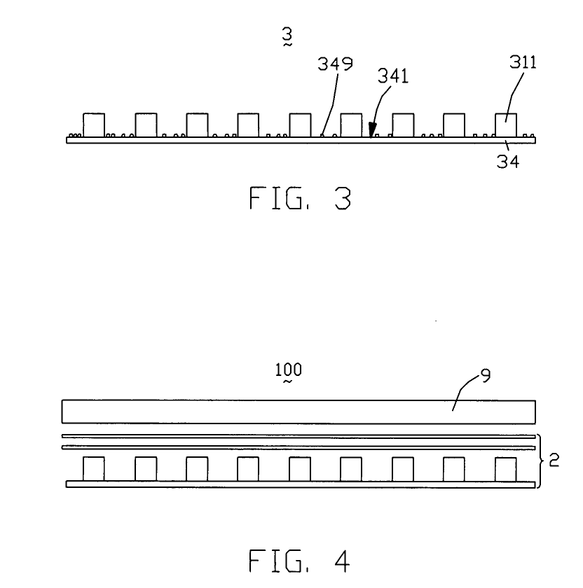

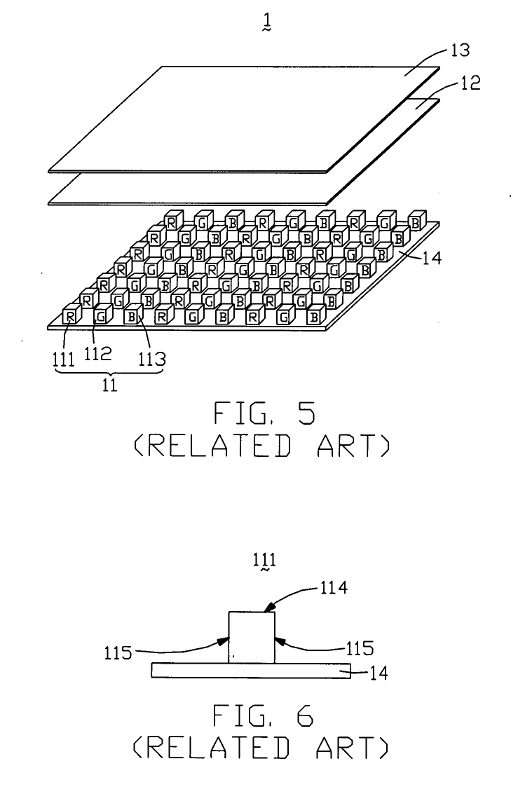

Referring to FIG. 3, this is an enlarged, side view of part of a backlight module in accordance with a second embodiment of present invention. The backlight module 3 includes a reflection sheet 34, and a plurality of LEDs 311. The reflection sheet 34 has a reflection surface 341. The LEDs 311 are formed on the reflection surface 341 of the reflection sheet 34, which has a structure similar to that of the red LED 211 as shown in FIG. 2.

A plurality of light-scattered structures 349 are formed on the reflection surface 341. The light-scattered structures 349 are formed of light reflecting material such as silver, can have convex structures, and can be arranged randomly or in a matrix. The light-scattered structure 349 can provide reflection and diffusion of light beams and increase the amount of color mixing. This helps ensure the backlight module 3 provides a uniformly white planar light source.

In alternative embodiments, the light-scattered structures 349 can be concave structures, which are also formed on the reflection surface 341. The light sources 311 can be arranged in a line forming at a side of the reflection sheet 34, known as a side-lighting backlight module.

Referring to FIG. 4, this is a schematic, side view of a liquid crystal display in accordance with a third embodiment of the present invention. The liquid crystal display 100 includes the backlight module 2 and a liquid crystal panel 9. The liquid crystal panel 9 is positioned adjacent the backlight module 2. Planar white light emitted from the backlight module 2 enters and illuminates the liquid crystal panel 9.

While preferred and exemplary embodiments have been described above, it is to be understood that the invention is not limited thereto. To the contrary, the above description is intended to cover various modifications and similar arrangements including as would be apparent to those skilled in the art. Therefore, the scope of the appended claims should be accorded the broadest interpretation so as to encompass all such modifications and similar arrangements.

What is claimed is:

1. A backlight module, comprising:
a light source comprising at least two light emitting diodes configured to emit different colored light respectively, each of the light emitting diodes comprising a top surface, a side surface adjacent to the top surface, and a reflection layer formed on the top surface.

2. The backlight module as claimed in claim 1, further comprising a third light emitting diode emits a third different color.

3. The backlight module as claimed in claim 2, the three different light emitting diodes emit red, green, blue light respectively.

4. The backlight module as claimed in claim 1, wherein the side surface is substantially perpendicular to the top surface.

5. The backlight module as claimed in claim 1, further comprising a diffuser provided above the light source.

6. The backlight module as claimed in claim 5, further comprising a reflection sheet provided below the light source.

7. The backlight module as claimed in claim 6, further comprising a plurality of light-scattering structures formed on the reflection sheet.

8. The backlight module as claimed in claim 7, wherein the light-scattering structures are convex.

9. The backlight module as claimed in claim 7, wherein the light-scattered structures are concave.

10. A liquid crystal display, comprising:
a reflection sheet;
a light source formed on the reflection sheet, the light source comprising at least two light emitting diodes configured to emit different colored light respectively, each of the light emitting diodes comprising a top surface, a side surface adjacent to the top surface, and a reflection layer formed on the top surface; and
a liquid crystal panel formed on the light source opposite to the reflection sheet.

11. The liquid crystal display as claimed in claim 10, further comprising a third light emitting diode emits a third different color.

12. The liquid crystal display as claimed in claim 11, the three different light emitting diodes emit red, green, blue light respectively.

13. The liquid crystal display as claimed in claim 10, wherein the side surface is substantially perpendicular to the top surface.

14. The liquid crystal display as claimed in claim 10, further comprising a diffuser provided below the light source.

15. The liquid crystal display as claimed in claim 14, further comprising plurality of light-scattering structures formed on the reflection sheet.

16. The liquid crystal display as claimed in claim 15, wherein the light-scattering structures are convex.

17. The liquid crystal display as claimed in claim 15, wherein the light-scattered structures comprises are concave.
